(19) United States
(12) Patent Application Publication
(10) Pub. No.: US 2007/0254505 A1
(43) Pub. Date: Nov. 1, 2007

(54) Grounding-type plug adapter

(76) Inventor: Cheng-Yuan Huang, Taipei County (TW)

Correspondence Address: CHENG-YUAN HUANG, 7F., No.213 Civic Boulevard Sec.4, Taipei, Taiwan, ROC AIRMAIL, 105, TW

(21) Appl. No.: 10/949,759

(22) Filed: Sep. 27, 2004

(51) Int. Cl. H01R 13/648

(52) U.S. Cl. 439/106

(57) ABSTRACT

A grounding-type plug adapter is externally provided at a first side with three slots for a three-pin plug to correspondingly plug thereinto, at a second side with a hot and a neutral blade having respective fixed polarity, and at a third side with a ground screw for screwing against a grounding wire, a checking device, and a testing device; and internally provided with a protective element connected to the ground screw, the neutral blade, and the checking device, and a resistance connected between the checking device and the testing device. The plug adapter is workable when the hot and neutral blades are correctly plugged into corresponding hot and neutral slots on a city electricity receptacle, and is able to lead induced current and leak current produced by an electric appliance to a grounding wire of the city electricity receptacle to protect the user's health and avoid electric shocks.

### FIELD OF THE INVENTION

The present invention relates to a grounding-type plug adapter, and more particularly to a grounding-type plug adapter that allows a plug with either a grounding prong or a grounding wire to plug therein for leading induced current and leak current produced by an electric appliance to a grounding wire of a city electricity receptacle, so as to protect a user's health and avoid undesirable electric shocks.

### BACKGROUND OF THE INVENTION

A plug adapter is a common power supply device for use with a grounding-type three-pin plug generally provided along with an electric appliance, so that the electric appliance could be indirectly electrically connected to a general city electricity receptacle that usually has only two plug slots.

An indoor city electricity receptacle is usually single-phase with two plug slots, which is useless for general grounding-type three-pin plugs. And, it is possible an electrician does not correctly connect wires in accordance with related electrical regulations. There are also household appliances equipped with a grounding wire and a two-pin plug without a grounding prong, and there is not necessarily a grounding device provided in the vicinity of the general city electricity receptacle, making the grounding wire equipped with the household appliances completely useless.

FIG. 4 shows a conventional grounding-type three-pin plug 70 having a grounding prong 71 with the function of eliminating electromagnetic radiation and leak current. To plug the three-pin plug into a receptacle having only two plug slots, most people would break or extract the grounding prong 71, resulting in a plug 70 without the function of eliminating electromagnetic radiation and leak current, and even resulting in undesirable electric shocks.

### SUMMARY OF THE INVENTION

A primary object of the present invention is to provide a grounding-type plug adapter for a plug having either a grounding prong or a grounding wire to plug therein, so as to lead induced current (electromagnetic wave) and leak current to a grounding wire of a city electricity receptacle to protect a user's health and avoid undesirable electric shocks.

To achieve the above and other objects, the grounding-type plug adapter of the present invention is externally provided at a first side with a ground slot, a hot slot, and a neutral slot for a three-pin plug to correspondingly plug thereinto, at a second side with a hot and a neutral blade having respective fixed polarity for correspondingly plugging into hot and neutral slots, respectively, on a general city electricity receptacle, and at a third side with a ground screw for screwing against a grounding wire, a checking device, and a testing device; and internally provided with a protective element electrically connected to the ground screw, the neutral blade, and the checking device, and a resistance connected to and between the checking device and the testing device. The plug adapter is workable when the hot and the neutral blade are correctly plugged into corresponding hot and neutral slots on the city electricity receptacle, and is able to lead induced current and leak current produced by an electric appliance to a grounding wire of the city electricity receptacle to protect the user's health and avoid electric shocks.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a grounding-type plug adapter according to an embodiment of the present invention;

FIG. 2 is a perspective view of the grounding-type plug adapter of FIG. 1 viewed from another angle;

FIG. 3 is a sectional view of the grounding-type plug adapter of FIG. 1; and

FIG. 4 is a schematical view of a conventional three-pin plug with a grounding prong.

### DETAILED DESCRIPTION OF THE PREFERRED EMBODIMENTS

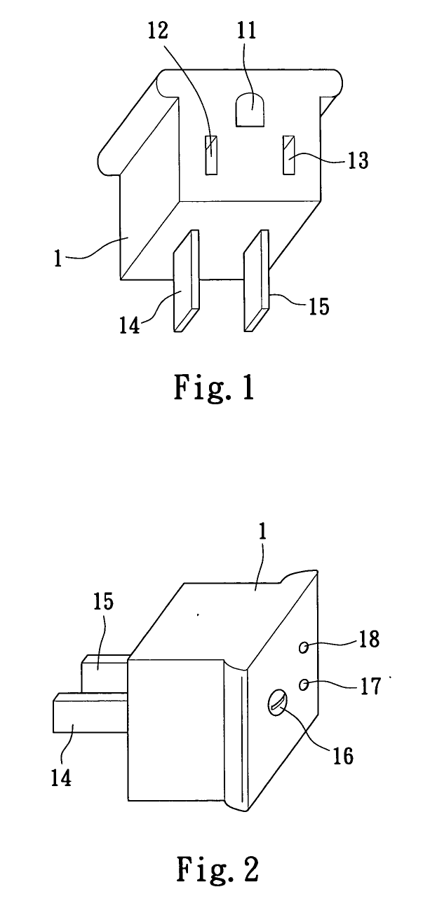

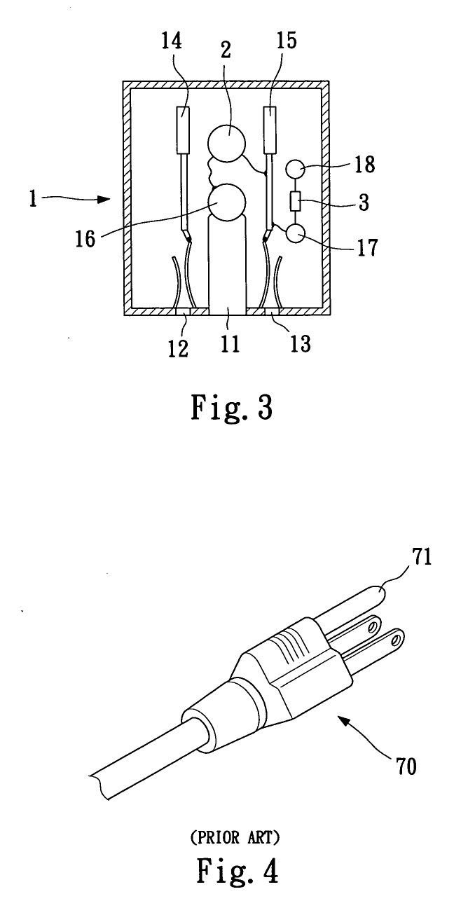

Please refer to FIGS. 1 and 2 that are two perspective views of a grounding-type plug adapter 1 according to an embodiment of the present invention viewed from different angles, and to FIG. 3 that is a sectional view of the grounding-type plug adapter shown in FIGS. 1 and 2.

As shown, the grounding-type plug adapter 1 is a substantially rectangular solid being externally provided at one side with a ground slot 11, a hot slot 12, and a neutral slot 13 for a three-pin plug to correspondingly plug thereinto, at a bottom side with two blades 14, 15 of fixed polarity for correspondingly plugging into hot and neutral slots, respectively, on a general city electricity receptacle, and at a top side with a ground screw 16 for screwing against a grounding wire, a checking device 17, which is a neon (Ne) bulb, and a testing device 18. The grounding-type plug adapter 1 is also internally provided with a protective element 2, which may be a fuse, or a low-impedance, low-wattage resistance, electrically connected to the ground screw 16, the blade 15, and the checking device 17, and a resistance 3 connected to and between the checking device 17 and the testing device 18.

After plugging the blades 14, 15 of the grounding-type plug adapter 1 of the present invention into a hot and a neutral slot, respectively, on a general city electricity receptacle, a user may touch the testing device 18 with a finger to test whether the blades 14, of the grounding-type plug adapter 1 are correctly plugged into corresponding hot and neutral slots on the receptacle. If not, the checking device 17 will turn on. At this point, the user needs only to unplug and turn the grounding-type plug adapter 1 before plugging the plug adapter 1 into the receptacle again, and then, touches the testing device 18 with one finger to ascertain the plug adapter 1 has been correctly plugged into the receptacle and the checking device 17 does not light.

The provision of the ground screw 16 enables the grounding-type plug adapter 1 of the present invention to be used with some household appliance plugs that are equipped with a grounding wire but not a grounding prong.

Moreover, when a three-pin plug of an electric appliance, such as a computer, is plugged into the three slots 11, 12, and 13 on the grounding-type plug adapter 1 of the present invention, it is possible to connect a plug with either a grounding prong or a grounding wire to the general city electricity receptacle, and to lead induced current (or electromagnetic wave) and leak current produced by the electric appliance to a grounding wire of the city electricity receptacle, so as to protect the user's health and avoid undesirable electric shocks. Moreover, it is possible to include an automatic interrupt overload protection in the grounding-type plug adapter 1 of the present invention to prevent an electric appliance, such as a computer, in operating from damages caused by short circuit, instantaneous surge, or thunder-struck.

What is claimed is:

1. A grounding-type plug adapter, comprising a substantially rectangular solid being externally provided at a first side with a ground slot, a hot slot, and a neutral slot for a three-pin plug to correspondingly plug thereinto, at a second side with a hot and a neutral blade having respective fixed polarity for correspondingly plugging into hot and neutral slots, respectively, on a general city electricity receptacle, and at a third side with a ground screw for screwing against a grounding wire, a checking device, and a testing device; and internally provided with a protective element electrically connected to said ground screw, said neutral blade, and said checking device, and a resistance connected to and between said checking device and said testing device; whereby said plug adapter is workable only when said hot and said neutral blade are correctly plugged into corresponding hot and neutral slots on the city electricity receptacle.

2. The grounding-type plug adapter as claimed in claim 1, wherein said protective element is selected from the group consisting of a fuse and a low-impedance, low-wattage resistance.

3. The grounding-type plug adapter as claimed in claim 1, wherein said checking device comprises a detecting circuit consisting of a resistance and a neon bulb.
